(19) United States
(12) Patent Application Publication
(10) Pub. No.: US 2007/0198147 A1
(43) Pub. Date: Aug. 23, 2007

(54) On-board diagnostic system including automatic communications bus disconnect

(76) Inventors: William J. Keith, Oglesby, IL (US); Kevin E. Nelson, Ottawa, IL (US); Jeffrey M. Patrick, Peru, IL (US)

Correspondence Address: RYAN KROMHOLZ & MANION, S.C., POST OFFICE BOX 26618, MILWAUKEE, WI, 53226, US

(21) Appl. No.: 11/505,780

(22) Filed: Aug. 17, 2006

Related U.S. Application Data
(60) Provisional application No. 60/709,788, filed on Aug. 19, 2005.

(51) Int. Cl. G01M 17/00

(52) U.S. Cl. 701/29; 701/33

(57) ABSTRACT

An on-board diagnostic (OBD) scan tool device is provided with a current sense disconnect to enable vehicular installation of the device whereby the device automatically senses the connection of another device to an OBD communications bus and prevents communication errors by disconnecting from the bus. The device prevents communication conflicts on an OBD bus that ordinarily occur when two OBD scan tools attempt to communicate on the same bus. The device includes a sense circuit to determine when another device is attached to the bus. When another device is sensed, switching components are used to disconnect transceivers from the OBD bus. Furthermore, virtually seamless integration into existing OBD systems is possible through the use of a Y-cable.

### RELATED APPLICATIONS

This application claims the benefit of co-pending U.S. Provisional Patent Application Ser. No. 60/709,788, filed Aug. 19, 2005.

### BACKGROUND OF THE INVENTION

The present invention relates generally to on-board diagnostic (OBD) systems, and more specifically to an on-board scan tool including an automatic communications bus disconnect that enables connection of a plurality of scan tools to a single OBD system.

On-board diagnostic (OBD) systems are generally known in the field of automotive maintenance, and indeed installation of them is required in many vehicles. OBD systems allow diagnosis and recordation of certain system parameters. It is desirable in some situations, such as fleet management, to have an OBD scan tool installed in a particular system. Fleet managers typically monitor data such as location, speed, fuel usage, mileage, air bag deployment, etc. Logging of this type of data can be accomplished by installing an OBD scan tool in the vehicle, as opposed to simply externally connecting one to a vehicle.

Currently, there exist many problems associated with vehicle-installed OBD scan tools, such as false error codes, bus collisions leading to corrupt communications, and connection latency.

The primary problem associated with vehicle-installed OBD scan tools is that communication problems occur when additional scan tools are connected, such as when vehicle diagnostics is run by a service technician. Some on-board scan tools attempt to address the problem. However, the main problem with conventional solutions is that some communications protocols remain operative when a subsequent device, such as an external OBD scan tool, attempts to establish communication on the same communications bus. The continued communication causes the external OBD device to show errors on the OBD bus leading to unnecessary maintenance on a vehicle.

Also, other potential communications problems are communications bus collisions that are caused by intermittent messages on the protocols that remain active. Bus collisions require an external OBD device to retry corrupted messages, possibly resulting in error codes being generated by the external device.

In addition to communications problems, connection latency is an extant problem. Present on-board devices wait a specific time period to stop communicating on the bus. Therefore, once an external device is connected, access to the bus by the external device is delayed and can result in significant connection latency.

### SUMMARY OF THE INVENTION

In view of the foregoing disadvantages inherent in the known types of on-board devices now present in the art, the present invention provides a new OBD scan tool device construction wherein the device enables vehicular installation of an internal OBD scan tool that automatically disconnects from the bus when another, external scan tool is connected. The device allows an internal OBD scan tool to be installed in a vehicle to acquire data requested by a fleet management application. To prevent communications conflicts on the vehicle's OBD communications bus, the internal device removes itself from the bus when an external device is sensed.

The present invention generally comprises an OBD scan tool including a sense circuit to determine when another device, such as an external scan tool, is attached to the bus. Switching components disconnect transceivers from the OBD bus. Blocking diodes prevent the reverse flow of current when the device is un-powered. A bypass diode provides the ability to pass current to an external OBD tool. Further, a Y-cable connects to a vehicle OBD port and passes power through the sense circuit to another OBD connection, which provides a diagnostic access port for an external device.

There has thus been outlined, rather broadly, certain features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary advantage of the present invention is that it provides an OBD scan tool device that will overcome the shortcomings of the prior art devices.

An advantage of the present invention is to enable installation of the device on a vehicle, wherein the device automatically disconnects from the OBD communications bus when another OBD device is connected.

Another advantage is that the tool disconnects from the OBD bus in a timely fashion, thereby preventing communication errors and allowing an external device to connect to the bus without delay and without any errors occurring.

Still another advantage is that the device reconnects to the OBD bus in a timely fashion when an external OBD device is removed from the OBD bus, thereby allowing an on-board application access to OBD data soon after the external device is removed.

Yet another advantage is that the device provides only minimal loading to an OBD bus when an external device is attached to the OBD bus. Unnecessary loading of the OBD bus may cause communication failures resulting in errors generated by the external OBD device. This may ultimately result in unnecessary maintenance on the vehicle.

A further advantage is that the device does not cause bus collisions when an external OBD device is attached. Bus collisions require the external device to retry protocol messages, possibly resulting in an error being generated by the external device.

Another advantage is that the device does not cause a significant drain on a vehicle battery.

A still further advantage is that the device preferably detects a current draw of an external scan tool without dropping a significant amount of voltage across the sensing element. If too much voltage is dropped across a sensing element it may cause problems with the external OBD device. Minimizing voltage drop is important if the system voltage is already at a low level.

Other advantages of the present invention will become obvious to the reader and it is intended that these advantages are within the scope of the present invention.

To the accomplishment of the above, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

FIG. 1 is a partial cut away perspective view of a system incorporating an embodiment of the present invention.

FIG. 2 is a representative block diagram of an embodiment of the present invention.

FIG. 3 is a schematic representation of a preferred embodiment of a connectivity sensor used in an embodiment of the present invention.

FIG. 4 is a schematic representation of a relationship between a first transceiver and switching components.

FIG. 5 is a schematic representation of a second transceiver and biasing circuitry.

FIG. 6 is a schematic representation of a relationship between a third transceiver and a switching component.

### DESCRIPTION OF THE PREFERRED EMBODIMENT

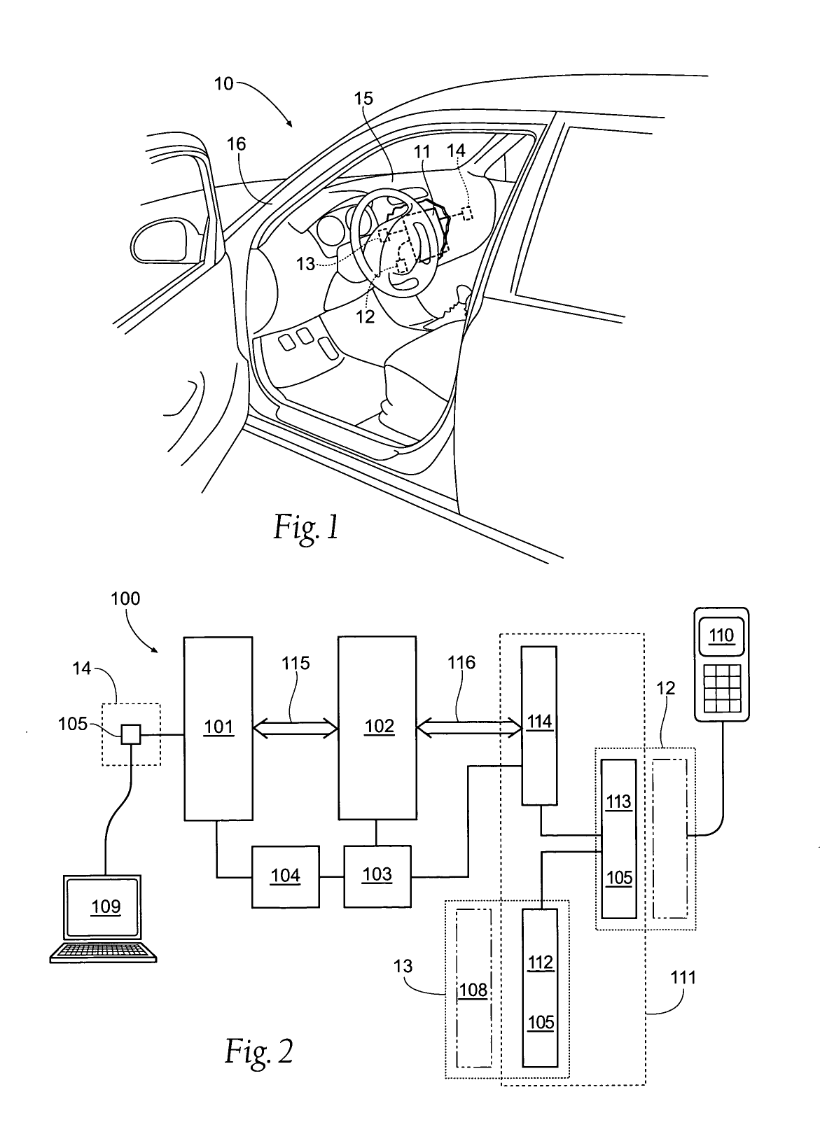

Referring to FIG. 1, a partial cut away view of a system 10 that incorporates a device embodiment 11 of the present invention is shown. Although shown installed behind the dashboard or driving console 15 of a vehicle 16, the device 11 could be installed anywhere on the vehicle 16. The device 11 connects to the vehicle 16 OBD system at one connector 13 and provides a diagnostic access port at a second connector 12 for an external OBD scan tool (not shown). Furthermore, the device 11 provides a data analysis access port 14 for external connectivity to external analysis tools, such as an external computer used to download stored data.

Now turning to FIG. 2, a representative block diagram of an embodiment of the present invention is shown. This embodiment comprises a current sense disconnect OBD scan tool device 100, which comprises a microcontroller 101, at least one transceiver 102, a connectivity sensor 103, a power supply 104, and external connection ports 105. While the power supply 104 could be a stand alone supply, specific to, and included with the device 100, it is preferable to connect the device 100 to the power supply of a vehicle in which it is installed. The microcontroller 101 facilitates control of the device 100 and logging of desired data. The transceiver 102 provides communications ability on at least one type of diagnostics bus 116, wherein the communication messages generally originate in the microcontroller 101 and are placed on the bus 116 by the transceiver 102. The transceiver 102 comprises at least one transceiver, preferably of the configuration of those in FIGS. 4-6, and may include multiple transceivers. External connection ports 105 are provided to enable connectivity to a vehicle OBD connector 108, to an external scan tool 110, and to an external data analysis tool 109. The connectivity sensor 103 determines when another device, such as an external scan tool 110, is coupled with the bus 116. Upon sensing an external tool 110, switching components are used to automatically disconnect the transceiver 102 from the OBD bus 116.

A Y-cable 111 connects the device 100 to the vehicle's original OBD connector 108 and passes power through the device 100 and to a second, diagnostic access port 113 that replaces the vehicle's original OBD connector 108. The Y-cable 111 comprises preferably three connectors: a DB15 male 114, an OBD female connector 113, and an OBD male connector 112. The OBD female connector 113 on the Y-cable 111 serves as the diagnostic access port for an external OBD device 110. The cable 111 preferably adheres to the OBD specification as far as wire size, current handling capability, and capacitance. This Y-cable 111 is specifically designed for an OBD device but could easily be converted for a heavy duty vehicle application utilizing Deutsch 9 and Deutsch 6 connectors.

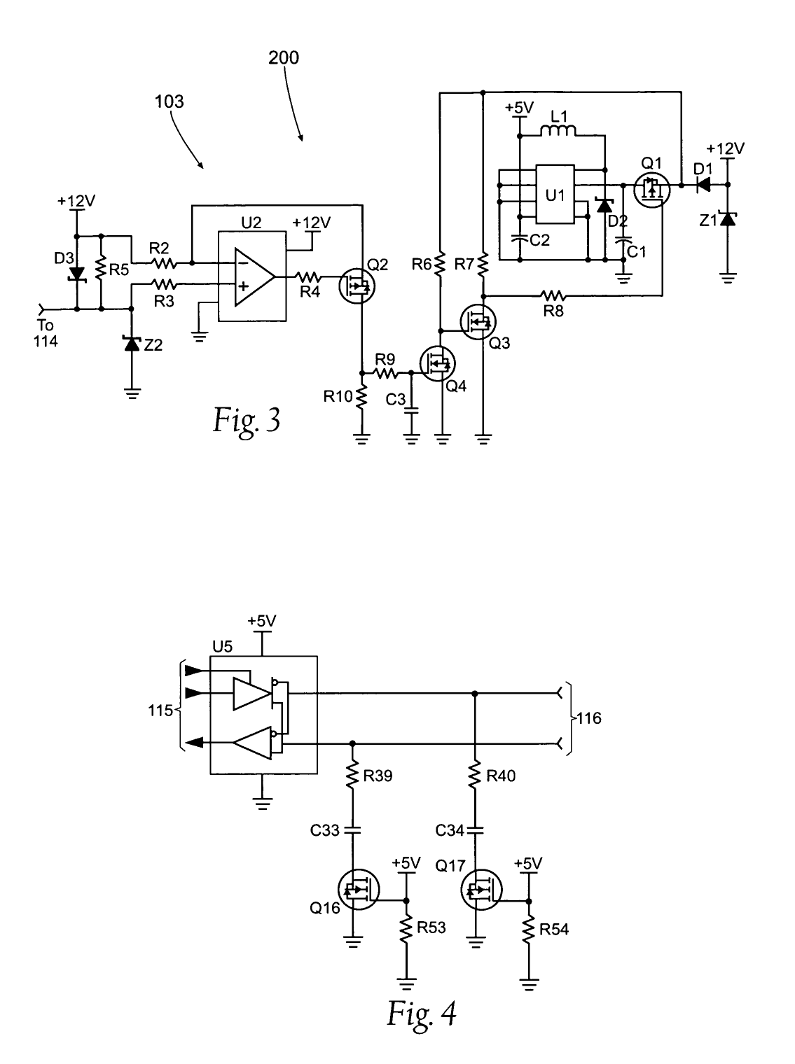

FIG. 3 depicts a schematic representation of the following preferred implementation of an embodiment of the connectivity sensor 103 used in the present invention. Generally, the circuit 200 comprises preferably a sense resistor R5 and an op-amp U2 to generate a signal indicative of subsequent device connection. More specifically, the circuit 200 comprises a sense resistor R5, an op-amp U2, switches Q1-4, and a voltage regulator U1. The current drawn by an external scan tool 110 passes through the sense resistor R5. The sense resistor R5 is able to handle the power generated by the current drawn through it by the external scan tool 110. The current drawn by the external scan tool 110 will generate a voltage across the sense resistor R5. The op-amp U2 preferably has a rail-to-rail input since the voltage differential across R5 will likely be small and the non-inverting input is at the power rail. The op-amp U2 also preferably has a small input offset voltage due to the small voltage that will be generated across the sense resistor R5. When used in a motor vehicle such as a car, the op-amp U2 preferably operates on a supply voltage in the range of about 8V to about 20V DC. Other voltages will be apparent to those in the art, depending on the specific application. Further, if the device is to remain active while the vehicle is inoperative, the op-amp U2 preferably has a low quiescent current to minimize drain on the vehicle battery. Different values can be used for the sense resistor R5 and biasing resistors R2 and R10 to change the trip point of the circuit 200. Larger resistor R5 values will reduce the output voltage supplied to the externally connected OBD device. Although the op-amp U2 can have a high quiescent current, such current draw may limit the time the vehicle can sit out of service. Although an op-amp U2 is preferred, the op-amp U2 could be replaced by a bipolar transistor. A transistor, however, may require a larger voltage to be dropped across the sense resistor R5 and therefore less voltage is available at the output for the externally connected OBD device.

The circuit 200 includes a bypass diode D3 intended to pass power to an externally connected device 110. The bypass diode D3 is preferably a high current Schottky diode. When the voltage across R5 reaches a certain level current begins to bypass the sense resistor R5 and flow through the diode D3. The bypass diode D3 is preferably rated for at least 4 amps because that is the minimum required by the OBD specification. Transient voltage suppressors Z1,Z2 protect against power spikes on the lines. R2 and R3 protect the op-amp U2 from power spikes above and below the power rails. The bypass diode D3 preferably has a small forward voltage drop so as to not interfere with an externally attached OBD device 110. Alternatively, a rectifier diode could be used instead of a Schottky diode, but a rectifier diode may drop additional voltage leaving less for the externally attached OBD device 110.

The circuit 200 and various transceiver biasing circuitry also includes switching components. The switching components Q are comprised generally of transistors and preferably MOSFETs. Both P type and N type MOSFETs are used. The switching components Q pass current and allow the circuit to operate when voltage is applied to the rest of the device 100. The MOSFETs Q are used in the circuit to activate the pull up and pull down resistors as well as some termination loads. The MOSFETs Q generally have a low on resistance so as to not affect the circuit 200. The transistors Q used in the circuit should be chosen with the peak operating voltage in mind. That is, the breakdown voltage of the chosen transistors Q preferably equals or exceeds the peak operating voltage of the system in which the device 100 is installed. While other transistors Q could be used, MOSFETs are preferred because they require only a voltage differential to operate, rather than current.

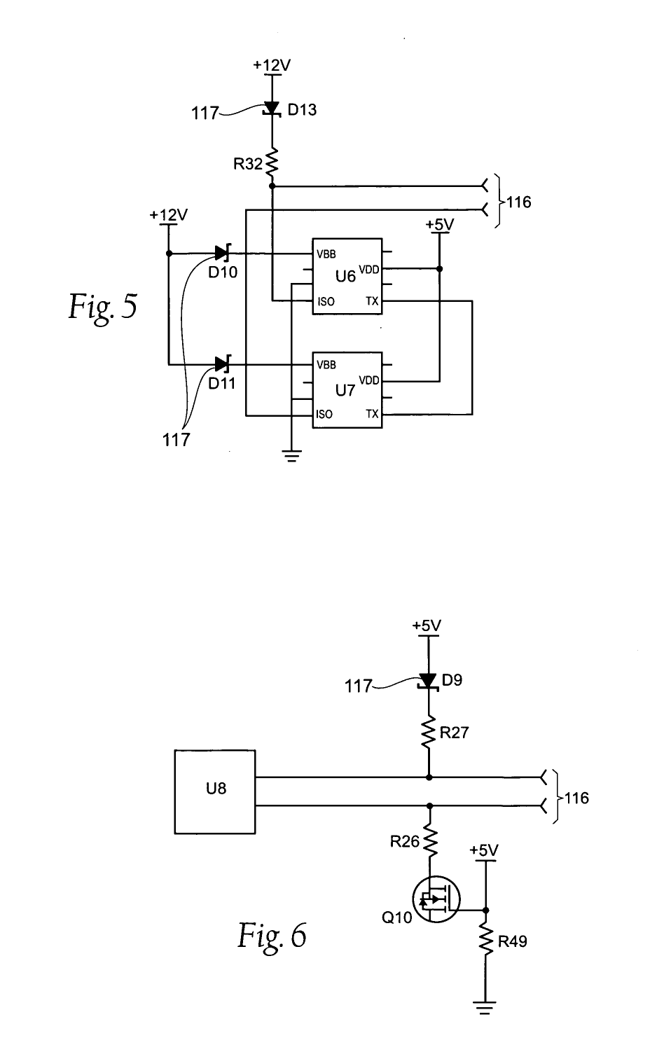

Referring also to FIGS. 4-6, representative transceiver circuits are shown. The interface transceivers are known in the art and may be of various types, including: SAE J1850 VPW, SAE J1850 PWM, ISO 9141, SAE J2284, and DaimlerChrysler SCI. FIG. 4 shows an SAE J2284 CAN transceiver U5 with switching components Q16,Q17. Specifically, with reference to FIGS. 5 and 6, blocking diodes 117 provide protection from reverse current flow. The blocking diodes 117 preferably comprise Schottky diodes on the power pins of certain OBD interface transceivers. FIG. 5 shows ISO transceivers U6,U7 with blocking diodes D10,D11,D13. FIG. 6 shows an SAE J1850 transceiver U8 with a switching component Q10 and a blocking diode D9. The blocking diodes 117 are preferably Schottky diodes due to their low forward voltage drop. Schottky diodes allow the maximum voltage to be presented to the OBD transceivers when power is applied. The Schottky diodes also preferably have a low reverse leakage current so that minimal loading is detectable on the OBD bus. A rectifier diode could be used instead of a Schottky diode, but a rectifier diode may drop additional voltage leaving less for the OBD transceivers. A rectifier diode would generally be acceptable as long as the transceivers can operate at a lower voltage.

Referring to FIG. 2, the basic connection of the device 100 may be understood. To use the device 100, the OBD male end 112 of the Y-cable 111 is plugged into the in-vehicle OBD connector 108. The OBD female connector 113 of the Y-cable 111 mimics the in-vehicle OBD female connector 108, thereby providing a diagnostic access port for an external device 110. The DB15 connector 114 on the Y-cable 111 is coupled to the device 100. As stated above, vehicle power is preferably used to power the device 101. Power can be taken from the OBD interface 108 on the vehicle. This power is routed from the Y-cable 111 OBD male connector 112 to the DB15 connector 114 and into the device 100. This power is then routed through the sense resistor R5 and the bypass diode D3 and to the diagnostic access port 113. This is the power that is preferably used for any external OBD device 110.

The operation of the device 101 can be better understood with reference to FIGS. 3-6. When an external OBD device 110 is plugged into the Y-cable female connector 113, current is drawn by the external device 110 through the sense resistor R5. This current causes a voltage drop across the sense resistor R5, which presents a voltage differential at the inputs of the op-amp U2. The op-amp U2 activates a MOSFET Q2 to draw current through a biasing resistor R2 causing a voltage drop across the biasing resistor R2 resulting in the potentials at the non-inverting and inverting inputs of the op-amp U2 to be equal. The current flowing through the biasing resistor R2 also flows through R10 creating a voltage drop across R10. A filter circuit R9,C3 is present to de-bounce noise spikes from ignitions and other interference. The voltage across R10 then charges the filter capacitor C3 through the filter resistor R9. Once the filter capacitor C3 is charged enough to meet the threshold voltage of MOSFET Q4, the MOSFET Q4 will turn on. Turning Q4 on causes MOSFET Q3 to turn off. Deactivation of Q3 causes deactivation of Q1, which electrically breaks the connection of power to a power regulator U1. The disconnect of power from the power regulator U1 interrupts the power supply to the rest of the device 100. Alternatively, the connectivity sensor 103 could also be used to control some other types of devices as opposed to the power regulator as is done in this system. For example, a relay or switch could be placed in line with the output of the power supply and controlled by the modified electrical signal generated by the sensor 103.

Referring now to FIGS. 4-6, to maintain a virtual open impedance state, when the circuit 200 powers down it deactivates switching MOSFETs Q10,Q16,Q17 which connect the pull up and pull down resistors and termination resistors of the OBD interfaces from the OBD bus. The power generated by the voltage regulator U1 is coupled to the gates of the N-type switching MOSFETs and causes them to deactivate when power is removed. MOSFET deactivation combined with the blocking diodes 117 where necessary, coupled to the transceivers effectively removes all loading circuits from the network thereby creating a virtual high impedance state on the bus 116 lines relative to the device 100. This allows an external OBD device 110 to connect to and communicate with the OBD network as if there were no other OBD scan tools connected to the OBD bus 116.

After external scanning is complete and the external OBD device 110 is removed, the current flow through the sense resistor R5 ceases, which allows the voltage at the op-amp U2 inputs to be equal. This causes the op-amp U2 to shut off Q2, stopping the current flow through R10. The capacitor C3 then discharges through R9 and R10 until the voltage at the gate of Q4 drops below the threshold voltage of Q4. At that time, Q4 turns off, resulting in Q1 and Q3 to turn on. Q1 turning on causes power to be applied to the voltage regulator U1 which powers up the rest of the device 100. When this power is activated it turns on the switching MOSFETs connecting the various OBD interfaces to the bus 116.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A diagnostic tool comprising:
a microcontroller coupled to a transceiver; and
a diagnostic access port coupled to a connectivity sensor and the transceiver;
wherein the diagnostic access port includes an electrical power access port and the connectivity sensor is adapted to alter an electrical signal upon detection of a load connected to the electrical power access port.

2. The diagnostic tool of claim 1, further comprising a data analysis access port coupled to the microcontroller.

3. The diagnostic tool of claim 1 wherein the transceiver is coupled to a communications bus and the altered electrical signal prevents the transceiver from loading the communications bus.

4. The diagnostic tool of claim 1 wherein the transceiver is coupled to a communications bus and the altered electrical signal prevents the transceiver from driving the communications bus.

5. The diagnostic tool of claim 3 wherein the altered electrical signal prevents the transceiver from driving the communications bus.

6. The diagnostic tool of claim 1, wherein the connectivity sensor comprises an operational amplifier coupled to a resistor, wherein the detection results from a sensed voltage across the resistor.

7. The diagnostic tool of claim 6, wherein the connectivity sensor further comprises a power regulator, and the altered electrical signal results in deactivation of the power regulator.

8. The diagnostic tool of claim 6, wherein the connectivity sensor further comprises:
a power regulator having an output coupled to other electrical components in the tool; and
a switch adapted to decouple the power regulator output from at least some of the other electrical components;
wherein the altered electrical signal controls the switch.

9. A method for preventing bus collisions in a diagnostic communications link having more than one diagnostic scanner connected, the method comprising the steps of:
sensing the connection of at least one of the diagnostic scanners; and
preventing substantially all modification of electrical signals on the link by all other scanners connected to the link.

10. The method of claim 9 wherein the sensing step comprises sensing a current draw through a resistor by sensing a voltage across the resistor.

11. A diagnostic tool comprising:
a Y-cable having a first connector, a second connector and a third connector, wherein the second connector is adapted to engage a vehicle on-board diagnostic port and the third connector provides a secondary diagnostic access port;
a vehicle-installed on-board diagnostic scan tool coupled to the first connector, wherein said scan tool comprises:
a microcontroller coupled to a transceiver, the transceiver further coupled to a communications bus;
a sensor coupled through the first connector to the third connector, wherein the sensor is adapted to detect connection of an external device to the third connector and to alter an electric signal upon such detection;
a switching component coupled to the transceiver and responsive to the altered electric signal, wherein the switching component removes substantially all loading of the link by the tool.

12. The diagnostic tool of claim 11 further comprising a power regulator, wherein the altered electric signal deactivates the power regulator.

13. The diagnostic tool of claim 11 wherein the load removal occurs within 10 milliseconds of external device connection.
